(19) United States
(12) Patent Application Publication
(10) Pub. No.: US 2012/0178057 A1
(43) Pub. Date: Jul. 12, 2012

(54) Electronic English Vocabulary Size Evaluation System for Chinese EFL Learners

(76) Inventor: Duanhe Yang, Kunming (CN)

(21) Appl. No.: 12/987,903

(22) Filed: Jan. 10, 2011

(51) Int. Cl. G09B 19/06

(52) U.S. Cl. 434/157

(57) ABSTRACT

Electronic English Vocabulary Size Evaluation System for Chinese EFL Learners constructs a word frequency table from the British National Corpus, and randomly extracts sample words from the word frequency table to construct productive and identification items. With the data from over 1,000 test takers, the modern test theory, Item Response Theory, is introduced to carry out the model fit test. The model fit probability value is taken as the standard to pick out items. Simultaneously, the three major parameters of the items are calculated. The qualified items are divided into ten grades and stored in the item bank. Then they are randomly extracted to form the test paper by applying the normal distribution theory. Finally, the confidence limit and interval estimation principles are used in the system to evaluate Chinese EFL learners' productive and identification English vocabulary sizes. Therefore, the system has a higher reliability, maneuverability and technicality.

### BACKGROUND OF THE PRESENT INVENTION

1. Field of Invention

The present invention relates to an evaluation system, and more particularly, to an electronic English vocabulary size evaluation system for Chinese EFL learners.

2. Description of Related Arts

Chinese and foreign scholars have studied the vocabulary acquisition, vocabulary size and the relationship between the vocabulary size and other basic skills of Chinese EFL (English as a foreign language) learners over the years. Accordingly, significant achievements have been gained at the vocabulary sampling criterion, the vocabulary test model building, the differentiating and defining of the learners' productive vocabulary size and their identification vocabulary size, the design of various types of test items, the calculating of the learners' vocabulary size, and the test item data statistical analysis.

It is well known that the vocabulary of any language contains all the information of that language. Therefore, the vocabulary acquisition is one of the most important tasks for EFL learners, and their English vocabulary size is a direct yardstick to their English proficiency. This is especially true to Chinese EFL learners since English and Chinese belong to quite different language families. The vocabulary measurement of Chinese EFL learners is thus a complicated system engineering. As a result, an efficient, reliable, valid and user-friendly electronic English vocabulary size evaluation system is designed and constructed for Chinese EFL learners by the present inventor. Not only can the system measure the learners' productive vocabulary size, it can also evaluate their identification vocabulary size (the productive vocabulary means those words and expressions learners can understand well and spell out correctly, while the identification vocabulary denotes those words learners can identify and understand but may not be able to correctly write out). Moreover, correctly understanding and using those English idioms, polysemy, synonymous, antonymous and homophonic words are also considered in the design and construction of this electronic system.

In fact, this system adopts the letters filling testing item to measure Chinese learners' productive vocabulary size, that is, the stem of an English word being tested has been deleted, only the prefix or the suffix of the word is left there as a hint for the learner. The learner is then asked to key in the missing letters after they read the Chinese explanation or the paraphrase of the word concerned and get to know what letters they should fill in. And the system takes multiple choice items to evaluate Chinese learners' identification vocabulary size. Those test items all contain an English word as the item stem, and the four choices are constructed in the Chinese language, of which one choice is the only correct Chinese counterpart or paraphrasing of the tested English words (the answer), the other three choices are distracters. Here the learners are simply required to click the choice they consider correct and adequate. That is why the present inventor proclaims this system “specially designed for and dedicated to all native Chinese EFL learners.”

Traditional English vocabulary size evaluation software are generally not firmly based on modern statistical principles for tested words sampling, test item pilot study, item bank design, test paper construction and vocabulary size evaluation, so they have a low reliability, validity, practicality and technicality.

### SUMMARY OF THE PRESENT INVENTION

An object of the present invention is to provide an electronic English vocabulary size evaluation system for Chinese EFL learners, which is capable of measuring not only Chinese learners' productive vocabulary size, but also their identification vocabulary size.

An object of the present invention is to provide an electronic English vocabulary size evaluation system for Chinese EFL learners, which makes use of the confidence limit and confidence interval estimation method, normal distribution principle of modern statistics to decide the upper limit and the lower limit of both the productive and identification English vocabulary size of the Chinese EFL learners.

An object of the present invention is to provide an electronic English vocabulary size evaluation system for Chinese EFL learners, which also makes use of the modern language testing theory—the Item Response Theory to carry out the model fit test so as to accurately select both productive and identification test items that are up to the standard. In this way, the system should have a much higher reliability, validity, practicality and technicality.

Accordingly, in order to accomplish the above objectives, the present invention provides an electronic English vocabulary size evaluation system for Chinese EFL learners, comprising the steps of:

(A) selecting tested sample words from the British National Corpus comprising:
(A1) setting the upper limit of the measurement of the vocabulary size for the system to 15,000 words;
(A2) extracting a total vocabulary for compiling test items of the vocabulary size measurement model comprising:
   (A2i) producing a raw word frequency table by selecting the highest frequently appeared 20,000 words from the British National Corpus through the use of the latest 5.0 Version of Wordsmith corpus software; and
   (A2ii) producing a new and shortened word frequency table from the raw word frequency table of 20,000 words as the only source for selecting words randomly for constructing all test items of the vocabulary size evaluation system later by excluding all person names and place names, all functional-grammatical words, all redundant cognate words of content-notional words, and all non-word symbols from the raw word frequency table, wherein the shortened word frequency table has 14,992 content words left, and the vocabulary size of the new word frequency table is taken to be 15,000 words;

(B) constructing the item bank comprising:
(B1) constructing the productive vocabulary size evaluation item bank, wherein the productive vocabulary size evaluation item bank comprises ten productive vocabulary size evaluation item sub-banks which are defined as the 1^{st}-grade productive item sub-bank, the 2^{nd}-grade productive item sub-bank, the 3^{rd}-grade productive item sub-bank and so on;
wherein the productive vocabulary size evaluation item bank has contained ten sets of test papers, each set of test paper comprises 90 test items, so that more than 900 productive vocabulary size test items are stored in the productive vocabulary size evaluation item bank;
wherein the step (B1) comprises:
   (B1i) dividing the 15,000 words in the new word frequency table into ten grades based on the frequency of appearance of the 15,000 words, wherein the ten grades are divided from the words with the highest frequency to the words with the lowest frequency in the new table; and
   (B1ii) constructing productive test items by randomly extracting tested words from the ten grades in step (B1i) and classifying the productive test items into corresponding graded productive item sub-banks; and
(B2) constructing the identification vocabulary size evaluation item bank, wherein the identification vocabulary size evaluation item bank comprises ten identification vocabulary size evaluation item sub-banks which are defined as the 1^{st}-grade identification item sub-bank, the 2^{nd}-grade identification item sub-bank, the 3^{rd}-grade identification item sub-bank and so on;
wherein the identification vocabulary size evaluation item bank has contained ten sets of test papers, each set of test paper comprises 90 test items, so that more than 900 identification vocabulary size test items are stored in the identification vocabulary size evaluation item bank,
wherein the step (B2) comprises:
   (B2i) dividing the 15,000 words in the new word frequency table into ten grades based on the frequency of their appearance, wherein the ten grades are divided from the words with the highest frequency to the words with the lowest frequency in the 15,000 word table; and
   (B2ii) constructing identification test items by randomly extracting tested words from the ten grades in step (B2i) and classifying the identification test items into corresponding graded identification item sub-banks, wherein once a word has been selected for constructing a productive vocabulary size item, the word will not be repeatedly selected to be a tested word for constructing an identification vocabulary size item, and vice versa;

(C) constructing test papers comprising:
(C1) constructing a set of productive vocabulary size test paper by randomly picking up corresponding number of test items from each of the ten productive item sub-banks according to the normal distribution principle; and
(C2) constructing a set of identification vocabulary size test paper by randomly picking up corresponding number of test items from each of the ten identification item sub-banks according to the normal distribution principle;

(D) calculating the productive vocabulary size of the test taker comprising:
(D1) calculating the score of the test taker, wherein when the test taker keys in those missing letters before or after the hint affixes, and if what he keys in is exactly the same as the correct answer stored in the system, the test taker will be scored one point, and if he keys in wrong letters, he cannot get any point, but no point shall be deducted;
(D2) after the step (D1), calculating the standard error of the proportion by the formula of

$$the standard error of the proportion = \sqrt{\frac{P ( 1 - P )}{N}} ,$$

of here P is the proportion of the number of correct answers to the number of total items in the test, and N is the number of total items in the test;
(D3) taking the 90% confidence interval according to the area distribution data under the normal distribution curve, wherein 90% confidence interval=the proportion of the number of correct answers to the number of the total items in the test±(1.64× the standard error); and
(D4) calculating the upper limit of the productive vocabulary size of the test taker by multiplying 15,000 by the upper limit of the 90% confidence interval, and calculating the lower limit of the productive vocabulary size of the test taker by multiplying 15,000 by the lower limit of the 90% confidence interval; and

(E) calculating the identification vocabulary size of the test taker comprising:
(E1) calculating the score of the test taker, wherein when the choice of the item clicked by the test taker is the same as the correct answer stored in the system, the test taker will be scored one point, and no point is deducted when the test taker clicks a wrong choice;
(E2) after the step (E1), adjusting the raw score by a correction formula of

$$N = R - \frac{W}{4} ,$$

developed in the Classical Testing Theory to get rid of the guessing element, here N is the corrected score, R is the number of correct answers, W is the number of wrong answers, and 4 is the number of the choices in the multiple choice item;
(E3) calculating the standard error of the proportion by the formula of

$$the standard error of the proportion = \sqrt{\frac{P ( 1 - P )}{N}}$$

, here P is the proportion of the number of correct answers to the number of total items in the test, and N is the number of total items in the test;
(E4) taking the 90% confidence interval according to the area distribution data under the normal distribution curve, wherein 90% confidence interval=the proportion of the corrected score to the number of the total items in the test±(1.64× the standard error); and
(E5) calculating the upper limit of the identification vocabulary size of the test taker by multiplying 15,000 by the upper limit of the 90% confidence interval, and calculating the lower limit of the identification vocabulary size of the test taker by multiplying 15,000 by the lower limit of the 90% confidence interval.

These and other objects, features, and advantages of the present invention will become more apparent from the following detailed description, the appended claims and the drawings.

### BRIEF DESCRIPTION OF THE DRAWINGS

FIG. 1 is a bar chart made by the software SPSS, showing the extraction procedure of the test items.

FIG. 2 is a flow chart of the extraction procedure of the productive vocabulary size evaluation test items and the formation of the test paper of 90 items.

FIG. 3 is a flow chart of the extraction procedure of the identification vocabulary size evaluation test items and the formation of the test paper of 90 items.

FIG. 4 shows the area under the normal curve, two-sided, 0.10.

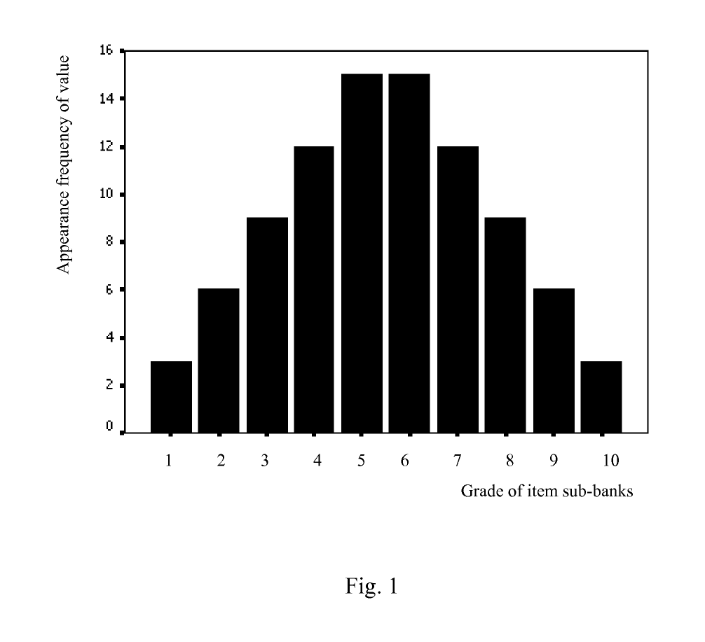

### DETAILED DESCRIPTION OF THE PREFERRED EMBODIMENT

The present invention is further detailedly explained with the accompanying drawings.

According to the statistics, about 5,000-18,000 words are used during daily communication by British and American people. The Teacher's Word Book, compiled by Thorndike, contains 20,000 words. These words are divided into 20 grades, and each grade has 1,000 words. And a lot of researches on English words which should be learned by EFL learners have been done by English educationists at home and abroad.

Some researchers think that 2,000 core words are the most basic requirement for understanding the English language (Nation, 1995), and 5,000 words are required for general English proficiency (Schmitt, 2000). However, some researchers consider that to command 3,000 words should be the most basic requirement, and 9,000-15,000 words are required for learners of more advanced English proficiency. Hazenburg thinks the Netherlands students should master 10,000 English words (Allen, 1983). Longman Dictionary of Contemporary English (2005) lists the most commonly used 3,000 words in spoken English and the most commonly used 3,000 words in written English. Oxford Word Power Dictionary (2004) marks the most commonly used 3,000 words with asterisk. The New Horizon Dictionary of the English Language, specially compiled for EFL learners, enlists 6,000 words, which are divided into 6 grades, wherein each grade has 1,000 words. Crashing Method of 5,000 English Basic Words, compiled by Professor Chuang Chun, Hong Kong, contains 5,000 words. Cambridge English Lexicon, compiled by Hindmarsh, also specially made for EFL learners, enlists about 4,500 words. Ogden's book, Basic English, lists the most basic 850 words (Wang Rongpei, 1998). Dictionary-7 Stage Important English Synonymous and Antonymous Words 8,000, compiled by Kajiki Ryuichi, Professor of Tokyo University, has 8,000 words. Taiwan education authorities require their middle school students to master 5,000 English words. However, the latest English vocabulary requirement for Taiwan's middle school students has increased to more than 6,300 words. In addition, reports show that the vocabulary size of 5,900 words is required for Japanese middle school students, 10,000 words are required for Japanese postgraduates, 9,000 words are required for Russian middle school students, and 15,000 words are required for Russian postgraduates.

The English vocabulary size requirements in China's school syllabi for university and high school students are shown in the following three tables.

TABLE 1
English vocabulary requirements in Chinese high school syllabi

| Publication Time of Syllabi/ | | |
|---|---|---|
| Standard Requirement (year) | Junior High School | Senior High School |
| 1992 | 1000 | 3000 |
| 2000 | 1200-1500 | 3200 |
| 2002 | 1500-1600 | 3500 |

TABLE 2
English vocabulary size requirements in Chinese University syllabi

| Publication Time of Syllabi/ | College/ | College/ | College/ |
|---|---|---|---|
| Standard Requirement (year) | University | University | University |
| 1980 | 1500-1800 | | |
| | College | College | Advanced |
| | English | English | English |
| | Test Band 4 | Test Band 6 | Courses |
| 1985 | 3800-4000 | 5000-5300 | 5800-6000 |
| 1988 | 4000-4200 | 5300-5500 | 5800-6000 |
| 1993 | 4000-4200 | 5300-5500 | 5800-6000 |
| 1999 | 4200-4500 | 5600-5800 | 6200-6500 |
| 2002 | 4400-4600 | 5700-6000 | 6500-6800 |

TABLE 3
English vocabulary size requirements in syllabi for Chinese University
English majors

| Publication Time of Syllabi/ | Test for English | Test for English |
|---|---|---|
| Standard Requirement (year) | Majors Band-4 | Majors Band-8 |
| 1989 | 5000-6000 | 9000-12000 |
| 2002 | 7000-8000 | 11000-13000 |
| | | The vocabulary for |
| The vocabulary in self-study | The vocabulary for | university |
| examination syllabi of English | junior college | undergraduate |
| majors | students | course |
| In 1998 | 5500 | 8000 |
| In 2002 | 6000 | 10000 |

Seen from the three tables above, and compared with the research results on the vocabulary size of the foreign learners and the vocabulary requirements in English teaching syllabi in some other countries and regions, the vocabulary requirements in English teaching syllabi in China are slightly lower. Therefore, according to the vocabulary required by Chinese compulsory education, college/university English syllabi, the present inventor's experiment and observation, the English vocabulary mastered by advanced Chinese English learners should be about 10,000 to 13,000 words.

Based on the above conclusion, the inventor sets the measurement upper limit of this electronic English vocabulary size evaluation system to be 15,000 words. It should be enough for most of the Chinese EFL learners, as he considers.

Then, as mentioned above, a word list of about 15,000 words is extracted from the most frequent 20,000 words in the British National Corpus. All the words selected to construct test items of this electronic system are randomly chosen from this 15,000 word list.

The British National Corpus is a very large English corpus of an international influence, and it has stored all types of English texts of various disciplines, specialties, genres and styles. In fact, it contains more than 100 million words in total. Using the latest 5.0 Version of Wordsmith Corpus Software, the inventor of the present electronic system extracts a raw word frequency table containing the most frequently occurred 20,000 words from the British National Corpus. Then he excludes all the person names and place names, such as Baker, Susan, Swift, Ireland and Mexico, excludes all the functional-grammatical words, such as prepositions on/in/before/after, conjunctions and/but, articles a/an/the, and interjections oh/ouch/wow etc., from the raw word frequency table. Simultaneously, all the redundant cognate words of the content words are excluded, that is, when the singular and plural forms of the same noun simultaneously occur in the raw word frequency table, all the plural nouns, such as “strategies”, will be excluded; when the cognate verb and noun simultaneously occur in the word frequency table, all the nouns, such as “assassination”, will be excluded; when the adjective and adverb forms simultaneously occur in the word frequency table, all the adverbs, such as “quickly”, will be excluded. As a result, all the functional-grammatical words and all the redundant cognate words of the content words are excluded. Furthermore, all non-word symbols, such as #, @ and &, identified in the raw word frequency table are also excluded. After kicking out all these words and symbols, the raw word frequency table has 14,992 content words left. They form a new, shortened word frequency list. The words in this new word frequency list are taken to be about 15,000, and they are divided into ten grades ranking downwards from the word of the highest frequency to the word of the lowest frequency. This new word frequency list is then taken as the only source from which all the tested words chosen to construct vocabulary size test items later are randomly selected.

The design standard of test items is described as follows.

The vocabulary size evaluation is further divided into two categories: productive vocabulary size evaluation and identification vocabulary size evaluation. The productive vocabulary means those words that learners can not only understand their meanings, but also accurately spell out. The identification vocabulary means those words that learners can generally understand the meaning when they encounter those words, but may not be able to spell out correctly. Generally speaking, for most EFL learners, their identification vocabulary size is much larger than their productive vocabulary size. Accordingly, the item bank of the electronic evaluation system of the present invention is made up of a productive vocabulary size evaluation item bank and an identification vocabulary size evaluation item bank. Both the two item banks contain over 900 items so that each bank can construct ten sets of test papers. And each set of test paper consists of 90 test items. All productive vocabulary size test items are constructed with those words randomly selected from the 15,000 word list and are designed as letter blank-filling items, that is, affixes of 2-4 letters at the beginning or the end of an English word are given as a hint, while the main part of the word is missing, and the part of speech, the Chinese interpretation or the paraphrasing of the English word is provided, so the test taker should key in the missing letters on the line as he or she considers right, so as to correctly spell out and reproduce the whole English word. In this system all the productive vocabulary size test items are designed in dark-red color.

All the identification vocabulary size test items are designed as multiple choice question items with four choices. The item stem is an English word randomly selected from the graded 15,000 word frequency list also, and the four choices are all in the Chinese language. One choice is the Chinese interpretation, paraphrasing or synonym, that is, the correct answer, of the tested English word, the other three are distracters. In this system, all the identification vocabulary size test items are designed in dark-blue color.

As mentioned above, all the words selected to construct test items are extracted from the 15,000-word frequency list based on the random sampling method. However, once a word is selected to construct a productive vocabulary size item, the word will no longer be reselected to be the stem for an identification vocabulary size item, and vice versa.

The constitution of a set of test paper is described below.

Based on the frequency of their appearance, from the highest frequency downwards, the 15,000 words in the new, shortened word frequency list are divided into ten grades.

The 1^{st} grade includes 1 to 1,500 of these words.

The 2^{nd} grade includes 1,501 to 3,000 of these words.

The 3^{rd} grade includes 3,001 to 4,500 of these words.

The 4^{th} grade includes 4,501 to 6,000 of these words.

The 5^{th} grade includes 6,001 to 7,500 of these words.

The 6^{th} grade includes 7,501 to 9,000 of these words.

The 7^{th} grade includes 9,001 to 10,500 of these words.

The 8^{th} grade includes 10,501 to 12,000 of these words.

The 9^{th} grade includes 12,001 to 13,500 of these words.

The 10^{th} grade includes 13,501 to 15,000 of these words.

Accordingly, all the tested words are randomly selected from the above ten grades and are used to design and construct the productive or identification test items. The productive or identification test items constructed are graded into the item banks based on these ten grades. So the productive vocabulary size evaluation item bank consists of ten item sub-banks accordingly defined as the 1^{st}-grade productive item sub-bank, the 2^{nd}-grade productive item sub-bank, the 3^{rd}-grade productive item sub-bank, and so on. Similarly, the identification vocabulary size evaluation item bank also consists of ten item sub-banks, defined as the 1^{st}-grade identification item sub-bank, the 2^{nd}-grade identification item sub-bank, the 3^{rd}-grade identification item sub-bank, and so on.

The extraction of the test items and the formation of the test paper make use of the normal distribution principle in the modern statistics. The normal distribution, just like the frequency distribution, is very important in the probability theory and common in the real world. Statisticians find that if data samples are comparatively large in both natural science and social science studies, they will basically show the tendency of normal distribution pattern. In addition, the normal distribution has some special mathematical characteristics for forecasting the distribution of values and variants. Therefore, based on the theory of normal distribution, the present inventor correspondingly extract different numbers of test items from each graded item sub-bank.

Since each set of test paper consists of 90 items, the number of items extracted from each graded item sub-bank can be predicted.

Therefore, each set of test paper has 3 items extracted from the 1^{st} grade item sub-bank, 6 items extracted from the 2^{nd} grade item sub-bank, 9 items extracted from the 3^{rd} grade item sub-bank, 12 items extracted from the 4^{th} grade item sub-bank, 15 items extracted from the 5^{th} grade item sub-bank, 15 items extracted from the 6^{th} grade item sub-bank also, 12 items extracted from the 7^{th} grade item sub-bank, 9 items extracted from the 8^{th} grade item sub-bank, 6 items extracted from the 9^{th} grade items sub-bank, and 3 items extracted from the 10^{th} grade item sub-bank.

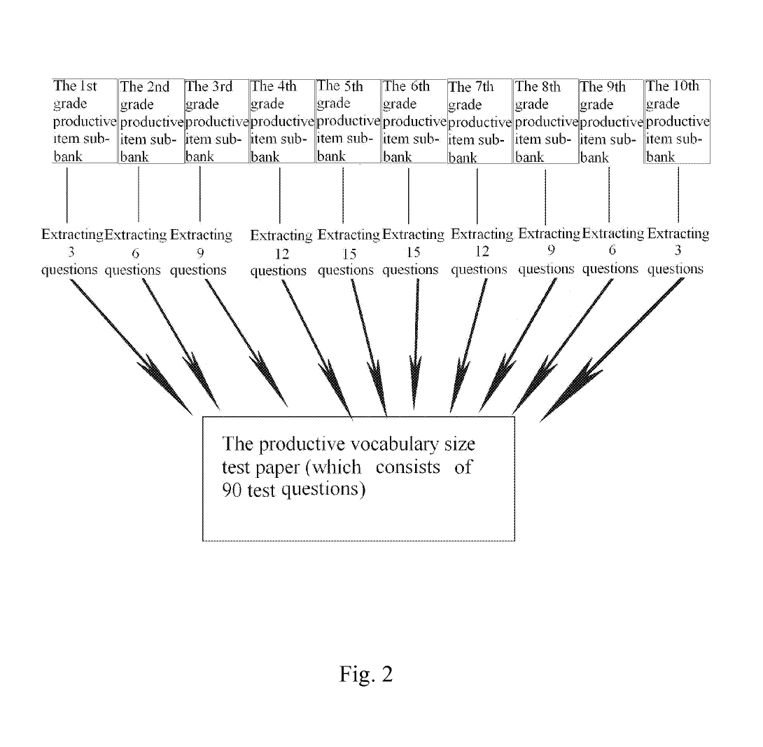

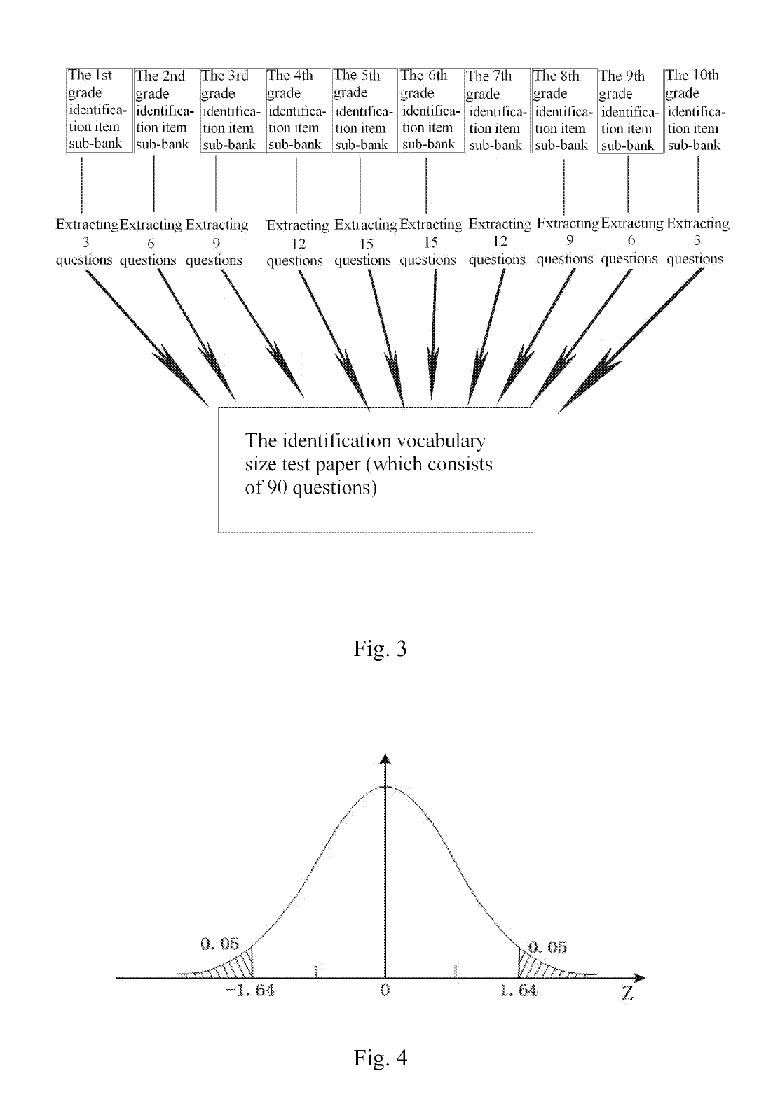

Accordingly, FIG. 2 is a flow chart of the extraction procedure of the productive vocabulary size evaluation test items and the formation of the test paper of 90 items, and FIG. 3 is a flow chart of the extraction procedure of the identification vocabulary size evaluation test items and the formation of the test paper of 90 items.

The total amount of all the test items in both the productive item bank and the identification item bank are described as follows.

Both the productive and identification item banks contain large amounts of items that can form ten sets of examination papers. And each set of examination paper is made up of 90 items. Therefore, there are more than 900 items which have been stored in the productive item bank, and another 900 more stored in the identification item bank after the trial-test with more than 1,000 subjects. Namely, more than 1,800 test items have been stored in the whole item bank.

The amount of all the test items in each of the ten productive vocabulary item sub-banks is listed below:

The productive 1^{st}-grade item sub-bank consists of 31 items.

The productive 2^{nd}-grade item sub-bank consists of 61 items.

The productive 3^{rd}-grade item sub-bank consists of 90 items.

The productive 4^{th}-grade item sub-bank consists of 120 items.

The productive 5^{th}-grade sub-item bank consists of 152 items.

The productive 6^{th}-grade item sub-bank consists of 151 items.

The productive 7^{th}-grade item sub-bank consists of 121 items.

The productive 8^{th}-grade item sub-bank consists of 90 items.

The productive 9^{th}-grade item sub-bank consists of 61 items.

The productive 10^{th}-grade item sub-bank consists of 31 items.

The amount of all the test items in each of the ten identification vocabulary item sub-banks is listed below:

The identification 1^{st}-grade item sub-bank consists of 40 items.

The identification 2^{nd}-grade item sub-bank consists of 60 items.

The identification 3^{rd}-grade item sub-bank consists of 91 items.

The identification 4^{th}-grade item sub-bank consists of 122 items.

The identification 5^{th}-grade item sub-bank consists of 151 items.

The identification 6^{th}-grade item sub-bank consists of 151 items.

The identification 7^{th}-grade item sub-bank consists of 121 items.

The identification 8^{th}-grade item sub-bank consists of 90 items.

The identification 9^{th}-grade item sub-bank consists of 61 items.

The identification 10^{th}-grade item sub-bank consists of 32 items.

The calculation method of the vocabulary size and the test score calculation procedure are explained as follows:

Firstly, the calculation of the productive vocabulary size and the test score calculation are introduced.

When the test taker clicks the button “Productive Vocabulary Size Evaluation” on the interface of the electronic system in accordance with the instruction, the system will automatically choose items of required numbers from each of the ten item sub-banks of the productive vocabulary size evaluation item bank randomly to form a set of test paper consisting of 90 items, and then the set of test paper is divided into 45 pages to be tested. The test items are displayed in the order of the ten item sub-banks, namely, from the items selected from the 1^{st}-grade item sub-bank, to the items selected from the 10^{th}-grade item sub-bank. When the test items are being displayed, the test taker answers the test items, the system begins to score and add the points.

The total score of each set of test paper is 90 points. The system requires that the test taker should key in the letters they think correct before or after the hint affixes of every item. The keyed-in letters and the order thereof must be the same as the answer stored in the system, otherwise, the item cannot be scored. Every correct answer will be scored one point. If he keys in wrong letters, however, no point is deducted.

After calculating the scores of the test taker, the system begins to calculate the standard error of the proportion, the confidence interval, the upper limit, lower limit and the median of the test taker's English productive vocabulary size. The formula of calculating the standard error of the proportion is reproduced below:

$$The standard error of the proportion = \sqrt{\frac{P ( 1 - P )}{N}}$$

Here P is the proportion of the number of correct answers to the number of total items in the test paper. N is the number of total items in the test paper (it is 90 here).

For example, if a test taker gets 39 items right while dealing with the productive vocabulary size test paper, then

$$\frac{39}{90} = 0.43 = P$$

(two digits after the decimal point are kept).

Accordingly,

$$the standard error of the proportion = \sqrt{\frac{0.43 \times ( 1 - 0.43 )}{90}} = \sqrt{\frac{0.43 \times 0.57}{90}} = 0.05$$

We should say that the number of test takers who have tried those items stored in this electronic English vocabulary size evaluation system is far more than 30. Therefore, according to normal distribution theory in modern statistics, we are very sure that the scores of those test takers are normally distributed. Then based on the area distribution data in the normal distribution curve, the present inventor finally decides to adopt the 90% confidence limit after he repeatedly calculates and experiments on many data. If selecting the 95% or a confidence limit higher than 95%, the confidence interval of the calculated vocabulary size will be rather wide. That is why the inventor has chosen the 90% confidence limit for this electronic vocabulary size evaluation system.

Now, let's refer to the normal distribution curve area table (from any statistics books) and calculate the Z-score. Since the confidence limit is 90%, the error probability will be 10%, namely, 0.1. From FIG. 4, we can see under the normal distribution curve, the two sides are shadowed, and each side, of course, takes 5 percent (0.05) of the total area.

Consulting the normal distribution curve area table in any statistics books, we get the Z-score, which is 1.64, based on the area of 0.05 under one side of the normal curve. If the Z-score is a positive value, a small area of 5% will be cut out at the tail of the right side to the center line. Of course, if the Z-score is negative, then a small area of 5% will be cut out at the tail of the left side to the center line. Under the normal curve, the 90% area is, therefore, between the Z-score of −1.64 and the Z-score of +1.64. In other words, the present inventor is quite sure that the calculated Z-score is between −1.64 and +1.64, and so we have 90% sureness that this conclusion is correct. Applying this principle to our Chinese learners' English vocabulary size evaluation system, we can formulate the procedure for calculating the English vocabulary size of the Chinese EFL learners:

90% confidence interval=the proportion of the number of the correct answers to the number of the total items±(1.64×the standard error)

Take the forgoing test taker, who gets 39 items right while answering the productive vocabulary size test paper, as an example. Now let's calculate the standard error of the proportion and the confidence interval for the test taker. Therefore:

$$The 90 \% confidence interval of the test taker = 0.43 \pm ( 1.64 \times 0.05 ) = 0.43 \pm 0.08 = 0.51 ( the upper limit ) - 0.35 ( the lower limit )$$

Since this system has set the measurement upper limit of the vocabulary size to be 15,000 words, so the largest vocabulary size measured is 15,000 words. Accordingly, multiply 15,000 by 0.51 and by 0.35 respectively, we will obtain the upper limit of the test taker's productive vocabulary size and the lower limit of his productive vocabulary size:

15,000×0.51=7650(the upper limit of the productive vocabulary size of the test taker)

15,000×0.35=5250(the lower limit of the productive vocabulary size of the test taker)

Now, get the average of the upper limit and the lower limit, namely, (7650+5250)+2=6450

In fact, the average is also the median of the productive vocabulary size of the test taker.

Then, the productive vocabulary size of the test taker is displayed on the productive vocabulary size statistics report interface by the system, as shown below:

### Your English Productive Vocabulary Size is Between 7,650-5,250 Words, Namely, about 6,450 Words

Secondly, the calculation principles of the identification vocabulary size and test score calculation are introduced as follows.

The procedure of extracting identification vocabulary size evaluation test items is exactly the same as the extraction of the productive vocabulary size evaluation test items. The identification vocabulary size evaluation test items are randomly selected from the ten identification vocabulary item sub-banks according to the proportion. The order of their appearance in the test paper and the scoring method of those items are also the same as those described in the productive test items extraction. Every correct answer is scored one point as well. For every multiple-choice item, the test taker can only click one choice. The total score is 90 points, too. No point is deducted if the test taker clicks a wrong choice.

When the test taker clicks the button “Identification Vocabulary Size Evaluation” on the interface, the system will automatically extract corresponding number of items from each of the ten item sub-banks of the identification vocabulary size evaluation item bank randomly to form a set of test paper consisting of 90 items, and then the set of test paper is divided into 45 pages to be tested. The test items are displayed in the order of the ten item sub-banks, namely, the test items selected from the 1^{st}-grade item sub-bank are given first; while the items selected from the 10^{th} grade item sub-bank are displayed last. While the test items being shown, the test taker answers them, and the system will begin to score and accumulate the points. After the test taker has completely answered all the items, however, the system will make use of the correction formula on multiple-choice items first to adjust the score so as to eliminate the guessing element of multiple-choice items. This correction formula is not used in the calculation of productive vocabulary size.

The correction formula is:

$$N = R - \frac{W}{4}$$

Here N is the corrected score. R is the number of correct answers. W is the number of wrong answers. And the denominator “4” is the number of the choices in the multiple-choice item.

For example, if a test taker gets a score of 69 after answering the identification vocabulary size test paper, then

$$N = 69 - \frac{90 - 69}{4} = 64$$

Therefore, his corrected score is 64.

After calculating the corrected score of the identification vocabulary test paper of the test taker, similarly, with the formulas used for calculating the standard error of the proportion and the 90% confidence interval adopted for the productive vocabulary size calculation, the standard error of the proportion and the 90% confidence interval of the identification vocabulary size test paper are obtained. Take the above corrected score 64 as the example:

$$The ratio = \frac{64}{90} = 0.71$$

$$\begin{matrix} Then the standard error = \sqrt{\frac{0.71 \times ( 1 - 0.71 )}{90}} \\ = \sqrt{\frac{0.71 \times 0.29}{90}} \\ = 0.048 \\ = 0.05\end{matrix}$$

$$the 90 \% confidence interval = 0.71 \pm ( 1.64 \times 0.05 ) \approx 0.71 \pm 0.08 \approx 0.79 ( the upper limit ) - 0.63 ( the lower limit )$$

15,000×0.79=11,850(the upper limit of the identification vocabulary size of the test taker)

15,000×0.63=9,450(the lower limit of the identification vocabulary size of the test taker)

Now get the average of the upper limit and the lower limit, namely, (11,850+9,450)÷2=10,650

These results are displayed on the identification vocabulary size statistics report interface by the system, as shown below:

### Your English Identification Vocabulary Size is Between 11,850-9,450 Words, Namely, about 10,650 Words

Next, the test items assessment procedure is explained as follows.

It should be emphasized at this stage that all the test items stored in both the productive and identification item banks have been tested by the three-parameter model of the Item Response Theory, one of the three mainstream modern measurement theories. In the item assessment stage, more than 1,000 test takers of different English proficiency participated in the item assessment. By using the internationally-popular Item Response Theory software made in the United States of America, BILOG-MG, the present inventor has calculated the three parameters of all the test items: Parameter B: the item facility index; Parameter A: the item discrimination index; and Parameter C: the item guessing coefficient. He also carries out the model fit test, thereby the model fit probability values of all the test items have also been calculated out. Then based on the model fit probability values, those test items that are up to the standard have been picked out and hence been stored in either the productive item bank or the identification item bank.

The Item Response Theory is a new measurement theory which was originated in the early part and fully-developed in the late last century. Based on the Latent Trait Theory, the Item Response Theory effectively resolves the problem that the Classical Testing Theory cannot identify the relationship between the test score and the test parameters because the Item Response Theory comprises:

1) the item parameters describing the item characteristics; and

2) the latent trait parameters describing the ability characteristics of the test taker.

In addition, compared with the Classical Testing Theory, the Item Response Theory has the following three advantages:

1) The evaluation on the parameters of the test items does not vary with different samples.

2) The evaluation of test takers' abilities does not vary with the different test contents.

3) The evaluation of measurement error does not vary with different test takers' abilities.

Furthermore, it is worth mentioning here that the Item Response Theory has three basic assumptions, too. Therefore, the present inventor finds it advantageous to use these three basic assumptions in the theory to assess his electronic vocabulary size evaluation system.

The three basic assumptions of the Item Response Theory are:

1) The One-dimension Assumption. It assumes that the test result of the test taker depends only on one ability assessed by the test, other factors which interfere with this ability can be generally neglected.

The assessment of the present electronic vocabulary size system with the One-dimension Assumption: the model in the present invention measures the English vocabulary ability of the Chinese EFL learners only, it does not involve the measurement of any other language abilities, such as their grammatical competence and their reading ability.

2) The Local Independence Assumption. It assumes that as the test taker is answering one item he is not being distracted by other items.

The assessment of the present electronic vocabulary size system with the Local Independence Assumption: the model in the present invention only assesses the mastering and understanding of an English word when it is presented independently. Therefore, the writing and understanding of the word being tested, or the correct spelling and the identifying of it will not be distracted by any other word items.

3) The Mathematical Model Assumption. It assumes that there is the proper application of the mathematical model and the model fit test should be conducted.

The assessment of the present electronic vocabulary size system with the Mathematical Model Assumption: based on the logistic mathematical model in the software BILOG-MG, the present inventor applies the maximum likelihood estimation to calculate the three important parameters of the Item Response Theory, namely, B (the item facility index), A (the item discrimination index) and C (the item guessing coefficient), of every test item, and the model fit probability values of every test item, too. All the test items picked out and stored in the item banks are well-fitted to the logistic model. The three important parameters and the model fit probability values of every test item evidently show that compared with applying the Classical Testing Theory, applying the Item Response Theory models to assess and select the test items for our electronic English vocabulary size evaluation system is more superior.

During his experimenting on and analyzing all the test items, the inventor found that only a very small amount of test items (about 2.4%) have the model fit probability values smaller than 0.05, so they cannot fit with the logistic model quite well at the level of 95%. Therefore, these small amounts of test items have been kicked out from the item bank. The test items that well-fit the logistic model and have been stored in the item bank take the rest 97.6%. These data sufficiently prove that this electronic English vocabulary size evaluation system for Chinese EFL learners meets the requirements of the three basic assumptions of the Item Response Theory.

In the last five years, the present inventor has carried out test item experiments on Chinese EFL learners of different proficiency in our country. The important three-parameters and the model fit probability values of all the test items are calculated out by applying the world-popular Item Response Theory software made in the United States of America, BILOG-MG, with the raw data obtained from these Chinese EFL learners. All the learners (subjects) involved in the test item experiments and their background are listed in the following table, Table 4.

TABLE 4
Those Chinese learners involved in the test item experiments of this
electronic English vocabulary size evaluation system

| Category | Male | Female | Total |
|---|---|---|---|
| Grade Three, Senior High School Students | 101 | 103 | 204 |
| University Junior Non-English Majors | 87 | 77 | 164 |
| University Senior Non-English majors | 85 | 83 | 168 |
| University Junior English Majors | 49 | 105 | 154 |
| University Senior English Majors | 54 | 121 | 175 |
| University Junior Non-English Majoring | 42 | 53 | 95 |
| Postgraduates | | | |
| University Senior Non-English majoring Post- | 38 | 45 | 83 |
| graduates | | | |
| University Junior English Majoring Post- | 31 | 37 | 68 |
| graduates | | | |
| University Senior English Majoring Post- | 29 | 36 | 65 |
| graduates | | | |
| University Young Non-English Majoring | 57 | 48 | 105 |
| Teachers | | | |
| University Young English Majoring Teachers | 45 | 64 | 109 |
| Total | 618 | 772 | 1390 |

According to the Item Response Theory, the calculated item parameters are closely related to the sample size, and the sample size of the three parameter model should be about 1,000 to 3,000 people. Therefore, the experimental sample size of more than 1,000 people taken by the present invention is adequate.

As previously described, the normal distribution is a very important distribution in statistics. The normal distribution has some special mathematical characteristics so that we can take advantage of it to predict the distribution of our Chinese learners' vocabulary size and the vocabulary variation between the learners of different proficiency, and from different areas. In general, our English vocabulary size evaluation samples are rather large. In fact, if the sample is larger than 30, the sample data can be regarded as “normally distributed”. Therefore, based on the mathematical characteristics of the normal distribution, the English productive and identification vocabulary size distribution patterns of our Chinese EFL learners of different proficiency, and from different areas can be identified and constructed through the use of this electronic system. As a result, more comprehensive and deeper studies of their English vocabulary size characteristics can be conducted. For instance, at a certain school, a certain college or university, in a certain region or city, or even nation-wide, the Chinese EFL learners' English vocabulary size distribution patterns can be identified, constructed and further studied. Of course, identifying and constructing these distribution patterns can also help our learners, English teachers and researchers gain more insight into the relationship between the learners' vocabulary test scores and the test scores of their other basic language skills, such as those of their listening comprehension and their reading ability, so that our researchers can have a better understanding of our Chinese EFL learners; our language teachers can be at a better position to help their EFL learners, and our Chinese EFL learners can better understand how to improve themselves.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An electronic English vocabulary size evaluation system for Chinese EFL learners, comprising:
(A) selecting tested sample words from the British National Corpus comprising:
(A1) setting the upper limit of the measurement of the vocabulary size for the system to 15,000 words;
(A2) compiling a total vocabulary list for designing and constructing test items of the vocabulary size measurement model comprising:
(A2i) producing a raw word frequency table of the highest-frequent 20,000 words from the British National Corpus to select tested words later through the use of the latest 5.0 Version of Wordsmith corpus software; and
(A2ii) producing a new and shortened word frequency table as the only source for selecting words randomly for constructing all test items of the vocabulary size measurement later for the system by excluding all person names and place names, all functional-grammatical words, all redundant cognate words of content-notional words, and all non-word symbols from the 20,000 word frequency table, wherein the shortened word frequency table has 14,992 content words left, and the vocabulary size of the new word frequency table is taken to be 15,000 words;
(B) constructing the item bank comprising:
(B1) constructing the productive vocabulary size evaluation item bank, wherein the productive vocabulary size evaluation item bank comprises ten productive vocabulary size evaluation item sub-banks which are defined as the 1^{st}-grade productive item sub-bank, the 2^{nd}-grade productive item sub-bank, the 3^{rd}-grade productive item sub-bank and so on;
wherein the productive vocabulary size evaluation item bank has contained ten sets of test papers, each set of test paper comprises 90 test items, so that more than 900 productive vocabulary test items are stored in the productive vocabulary size evaluation item bank;
wherein the step (B1) comprises:
(B1i) dividing the 15,000 words in the new word frequency table into ten grades based on the frequency of the appearance of the 15,000 words, wherein the ten grades are divided from the words of the highest frequency to the words of the lowest frequency in this new word table; and
(B1ii) constructing productive test items by randomly extracting tested words from the ten grades in step (B1i), classifying and storing the productive test items into the corresponding graded productive item sub-banks; and
(B2) constructing the identification vocabulary size evaluation item bank, wherein the identification vocabulary size evaluation item bank comprises ten identification vocabulary size evaluation item sub-banks which are defined as the 1^{st}-grade identification item sub-bank, the 2^{nd}-grade identification item sub-bank, the 3^{rd}-grade identification item sub-bank and so on;
wherein the identification vocabulary size evaluation item bank has contained ten sets of test papers also, each set of test paper comprises 90 test items, so that more than 900 identification vocabulary test items are stored in the identification vocabulary size evaluation item bank,
wherein the step (B2) comprises:
(B2i) dividing the 15,000 words in the new word frequency table into ten grades based on the frequency of the appearance of the 15,000 words, wherein the ten grades are divided from the words with the highest frequency to the words with the lowest frequency in this new word table; and
(B2ii) constructing identification test items by randomly extracting tested words from the ten grades in step (B2i), classifying and storing the identification test items into the corresponding graded identification item sub-banks, wherein once a word has been selected from the graded 15,000 words frequency table for constructing a productive vocabulary item, the word will not be repeatedly selected to be a tested word for constructing an identification vocabulary item, and vice versa;
(C) constructing test papers comprising:
(C1) constructing a productive vocabulary size test paper by randomly picking up corresponding number of test items from each of the ten productive item sub-banks according to the normal distribution principle; and
(C2) constructing an identification vocabulary size test paper by randomly picking up corresponding number of test items from each of the ten identification item sub-banks according to the normal distribution principle;
(D) calculating the productive vocabulary size of the test taker comprising:
(D1) calculating the score of the test taker, wherein when the test taker keys in those missing letters before or after the hint affixes of a productive vocabulary size test item, and if what he keys in is exactly the same as the correct answer stored in the system, the test taker will be scored one point, and if he keys in wrong letters, he cannot get any point, but no point shall be deducted;
(D2) after the step (D1), calculating the standard error of the proportion by a formula of
$$the standard error of the proportion = \sqrt{\frac{P ( 1 - P )}{N}} ,$$
here P is the proportion of the number of correct answers to the number of total items in the test, N is the number of total items in the test;
(D3) taking the 90% confidence interval according to the area distribution data under the normal distribution curve, wherein 90% confidence interval=the proportion of the number of correct answers to the number of the total items±(1.64× the standard error); and
(D4) calculating the upper limit of the productive vocabulary size of the test taker by multiplying 15,000 by the upper limit of the 90% confidence interval, and calculating the lower limit of the productive vocabulary size of the test taker by multiplying 15,000 by the lower limit of the 90% confidence interval; and
(E) calculating the identification vocabulary size of the test taker comprising:
(E1) calculating the score of the test taker, wherein when the choice of the item clicked by the test taker is the same as the correct answer stored in the system, the test taker will be scored one point, and no point is deducted when the test taker clicks a wrong choice;
(E2) after the step (E1), adjusting the raw score by a correction formula of
$$N = R - \frac{W}{4} ,$$
developed in the Classical Testing Theory to get rid of the guessing element, here N is the corrected score, R is the number of correct answers, W is the number of wrong answers, and 4 is the number of the choices in the multiple choice item;
(E3) calculating the standard error of the proportion by the formula of
$$the standard error of the proportion = \sqrt{\frac{P ( 1 - P )}{N}} ,$$
here P is the proportion of the correct score to the number of total items in the test, N is the number of total items in the test;
(E4) taking the 90% confidence interval according to the area distribution data under the normal distribution curve, wherein 90% confidence interval=the proportion of the correct score to the number of the total items in the test±(1.64× the standard error); and
(E5) calculating the upper limit of the identification vocabulary size of the test taker by multiplying 15,000 by the upper limit of the 90% confidence interval, and calculating the lower limit of the identification vocabulary size of the test taker by multiplying 15,000 by the lower limit of the 90% confidence interval.

2. The electronic English vocabulary size evaluation system, as recited in claim 1, wherein all productive vocabulary size test items are designed and constructed as English word letter blank filling items in dark-red color, that is, the main part of the tested English word has been deleted, only the beginning or the end affixes of the word are left there, wherein the part of speech, the Chinese explanation or paraphrasing of the word is given as a clue to help the test taker fill in the correct letters and reconstruct the tested word.

3. The electronic English vocabulary size evaluation system, as recited in claim 1, wherein all identification vocabulary size test items are designed and constructed as multiple choice items in dark-blue color containing four choices, wherein the stem of the multiple choice item is the tested English word, the four choices are in Chinese, wherein one choice is the Chinese interpretation phrase or synonyms (near-synonyms), that is, the correct answer, of the tested word, and the other three choices are distracters.

4. The electronic English vocabulary size evaluation system, as recited in claim 1, wherein the 1^{st} grade productive item sub-bank comprises 31 items, the 2^{nd} grade productive item sub-bank comprises 61 items, the 3^{rd} grade productive item sub-bank comprises 90 items, the 4^{th} grade productive item sub-bank comprises 120 items, the 5^{th} grade productive item sub-bank comprises 152 items, the 6^{th} grade productive item sub-bank comprises 151 items, the 7^{th} grade productive item sub-bank comprises 121 items, the 8^{th} grade productive item sub-bank comprises 90 items, the 9^{th} grade productive item sub-bank comprises 61 items, the 10^{th} grade productive item sub-bank comprises 31 items.

5. The electronic English vocabulary size evaluation system, as recited in claim 1, wherein the 1^{st} grade identification item sub-bank comprises 40 items, the 2^{nd} grade identification item sub-bank comprises 60 items, the 3^{rd} grade identification item sub-bank comprises 91 items, the 4^{th} grade identification item sub-bank comprises 122 items, the 5^{th} grade identification item sub-bank comprises 151 items, the 6^{th} grade identification item sub-bank comprises 151 items also, the 7^{th} grade identification item sub-bank comprises 121 items, the 8^{th} grade identification item sub-bank comprises 90 items, the 9^{th} grade identification item sub-bank comprises 61 items, the 10^{th} grade identification item sub-bank comprises 32 items.

6. The electronic English vocabulary size evaluation system, as recited in claim 1, wherein in step (C), according to the normal distribution principle, extracting 3 items from the 1^{st} grade productive item sub-bank, extracting 6 items from the 2^{nd} grade productive item sub-bank, extracting 9 items from the 3^{rd} grade productive item sub-bank, extracting 12 items from the 4^{th} grade productive item sub-bank, extracting 15 items from the 5^{th} grade productive item sub-bank, extracting 15 items from the 6^{th} grade productive item sub-bank also, extracting 12 items from the 7^{th} grade productive item sub-bank, extracting 9 items from the 8^{th} grade productive item sub-bank, extracting 6 items from the 9^{th} grade productive item sub-bank, and finally, extracting 3 items from the 10^{th} grade productive item sub-bank to form a set of productive vocabulary size test paper of 90 items, and wherein the extraction of the identification test items is exactly the same as that of the productive test items.

7. The electronic English vocabulary size evaluation system, as recited in claim 1, wherein in step (C), according to the normal distribution principle, 3 items from the 1^{st} grade identification item sub-bank are extracted, 6 items from the 2^{nd} grade identification item sub-bank are extracted, 9 items from the 3^{rd} grade identification item sub-bank are extracted, 12 items from the 4^{th} grade identification item sub-bank are extracted, 15 items from the 5^{th} grade identification item sub-bank are extracted, 15 items from the 6^{th} grade identification item sub-bank are extracted also, 12 items from the 7^{th} grade identification item sub-bank are extracted, 9 items from the 8^{th} grade identification item sub-bank are extracted, 6 items from the 9^{th} grade identification item sub-bank are extracted, and finally, 3 items from the 10^{th} grade identification item sub-bank are extracted to form a set of identification vocabulary size test paper of 90 items.

8. The electronic English vocabulary size evaluation system, as recited in claim 1, further comprising calculating the three important parameters: Parameter B (the facility index), Parameter A (the discrimination index) and Parameter C (the guessing coefficient), and the model fit probability values of all the test items within the framework of the Item Response Theory by applying the joint maximum likelihood estimation based on the logistic mathematical model of the BILOG-MG, the world-popular Item Response Theory software made in the United States of America, and picking out the qualified test items by referring to the model fit probability values as the standard.

9. The electronic English vocabulary size evaluation system, as recited in claim 1, further comprising constructing the distribution model of the English vocabulary size of the Chinese EFL learners of different proficiency, and from different areas.
